(19) United States
(12) Patent Application Publication
(10) Pub. No.: US 2021/0320533 A1
(43) Pub. Date: Oct. 14, 2021

(54) COVERING PANEL AND FASTENING SYSTEM COMPRISING SAID PANEL, PROCESS FOR FASTENING AND ELECTRONIC DEVICE

(71) Applicant: LYM S.R.L., Sacile (IT)

(72) Inventors: Davide DEPLANO, Cordignano (IT); Andrea CARLET, Cordignano (IT)

(21) Appl. No.: 17/266,308

(22) PCT Filed: Aug. 8, 2019
(86) PCT No.: PCT/IB2019/056750

§ 371 Date: Feb. 5, 2021

(30) Foreign Application Priority Data
Aug. 8, 2018 (IT) 102018000007975

(51) Int. Cl. H02J 50/40; H02J 50/10; H01F 7/02; E04F 13/08; E04C 2/28; E04C 2/52; G08B 5/36

(52) U.S. Cl. CPC H02J 50/40; H02J 50/10; H01F 7/02; G08B 5/36; E04C 2/28; E04C 2/52; E04F 13/0866

(57) ABSTRACT

A covering panel for buildings includes: A) a ferromagnetic layer containing ferromagnetic material; B) one or more structural layers made of one or more materials which are substantially non-ferromagnetic; C) a signal light, which is visible, observing the major front face of the covering panel from the outside; and D) one or more wireless power supply stations, each of which supplies power to one or more electrical or electronic devices. The signal light is arranged at, or close to, one of the wireless power supply stations, for example, at, or close to, its possible inductor or capacitive plate, to allow a user to easily find the position of the power supply station, even though it is hidden in or behind the covering panel.

### CROSS REFERENCE TO RELATED APPLICATIONS

The present application the national stage of International Patent Application No. PCT/IB2019/056750, filed on Aug. 8, 2019, which claims priority to Italian patent application no. IT102018000007975, filed on Aug. 8, 2018, all of which said applications are hereby incorporated by reference in their entirety.

### TECHNICAL FIELD

The present disclosure concerns a covering panel for covering, for example, parts of pre-existing buildings or making new ones, like for example partitions, a fastening system of electrical and electronic equipment that uses such a panel, an electrical or electronic device suitable for being fixed to such a covering panel and a method for fastening electrical or electronic equipment to such panels.

With such covering panels and such a fastening system it is possible to reversibly fasten electrical or electronic devices, for example to walls or ceilings, powering them with more freedom and safety with respect to current fastening and energy transfer systems.

### BACKGROUND

From publication WO2018/025230A1 a lighting system is currently known comprising one or more lamps capable of moving autonomously on plasterboard panels that cover, for example, the walls or the ceiling of a room.

Such lamps adhere to the plasterboard panels thanks to the attraction between magnets, mounted on-board the self-moving lamps, and one or more layers of ferromagnetic material contained in the plasterboard panels.

The plasterboard covering panels described in document WO2018/025230A1 can be provided with inductive wireless chargers hidden inside or behind the covering panels themselves, allowing the self-moving lamps to be charged or powered, simply fixed magnetically to the walls covered by said panels.

It is thus possible to make rooms equipped with many completely invisible charging points, having a very elegant, minimalist and basic appearance; although very rich in services and convenience.

Since they are completely hidden in the plasterboard panels, the chargers are also totally unreachable, for example by children, and therefore are much safer than conventional plug sockets with visible holes.

However, it is necessary to indicate the position of the various chargers, to allow users to magnetically fasten the various devices to be powered at the correct point of a wall.

Simply indicating the areas of the panels, sufficiently close to the windings of the inductors, with colours or marks (drawn or painted on the applied and finished panels, or printed on stickers stuck in turn onto the applied and finished panels) is not a very practical solution because it presumes that the position of the chargers hidden in the finished wall is known.

In any case, this first solution would not allow the charging points to be found in the dark, in portions of wall that are poorly lit or filled with other images; moreover, it does not make it possible to indicate to the end user whether the charger is actually working, out of order or even simply not powered.

One of the purposes of the present disclosure is therefore to improve the covering panels described in document WO2018/025230A1 allowing an end user to find more easily the areas of a panel, of a room, of another space or structure covered by panels, in which wireless charging or in any case power transfer points are to be found.

### SUMMARY

Such a purpose is accomplished, in a first aspect of the present disclosure, with a covering panel having the features according to an independent claim.

In a second aspect, the disclosure concerns a fastening system having the features according to another claim.

In a third aspect of the disclosure, such a purpose is accomplished with a method having the features according to a further independent claim.

In a fourth aspect thereof, the present disclosure, concerns an electrical or electronic device having the features according to claim 13.

In a panel, according to a particular embodiment, the insert in which a nut screw (68) is formed is fitted or screwed into at least one or more structural layers (52, 53, 56) and/or through the ferromagnetic layer (54, 54′).

In a panel, according to a particular embodiment, the light source (62) comprises a light emitting diode.

In a panel, according to a particular embodiment, the protective shield (64) forms a threaded pin and at least one end arranged at or close to the major front face (5100) of the panel (51) itself.

A notch is formed on such an end, said notch being arranged to engage with the tip of a screwdriver, for example flat-headed, cross-headed or hexagonal, allowing the protective shield (64) to be screwed in and unscrewed.

In a panel, according to a particular embodiment, the ferromagnetic layer (54) comprises a sheet of metal having an average or nominal thickness, equal to or greater than 0.1 millimetres, and preferably comprised between 0.2-1 millimetres.

In a particular embodiment of such a fastening system, the electrical or electronic device, or other electrical load devices 10A to be fastened to one or more covering panels (51), is provided with its own power supply unit (205) arranged to be powered by a wireless power supply station (57), inside the panel, for example of the inductive or capacitive type.

The advantages that can be obtained with the present disclosure will become clearer, to those skilled in the art, from the following detailed description of some particular non-limiting embodiments, illustrated with reference to the following schematic figures.

### BRIEF DESCRIPTION OF THE DRAWINGS

FIG. 1 shows a perspective view of the major front face of a covering panel, according to a first embodiment of the present disclosure;

FIG. 2 shows a cross section of the panel of FIG. 1;

FIG. 3 shows a perspective view, partially in section, of the charger of the panel of FIG. 1;

FIG. 4 shows a perspective view of the major rear face of the panel of FIG. 1;

FIG. 5 shows an exploded perspective view of the major rear face of the panel of FIG. 1;

FIG. 6 shows a perspective view of the major rear face of a covering panel, according to a second embodiment of the disclosure;

FIG. 7 shows an exploded perspective view of the major rear face of the panel of FIG. 6;

FIG. 8 shows a perspective view of the major front face of the panel of FIG. 6;

FIG. 9 shows an exploded perspective view of the signal light of the panel of FIG. 6;

FIG. 10 shows a perspective view of the front face of a first example of a fastening support adapted for fastening electrical or electronic devices to be powered, to a panel of FIG. 1 or 6;

FIG. 11 shows a perspective view of the front face of the fastening support, with an example of anchoring through threaded holes, of FIG. 10; and

FIG. 12 shows an exploded perspective view of an electrical or electronic device, specifically a lamp, adapted for fastening to and receiving energy from the panel of FIG. 1 or 6.

### DETAILED DESCRIPTION OF THE DRAWINGS

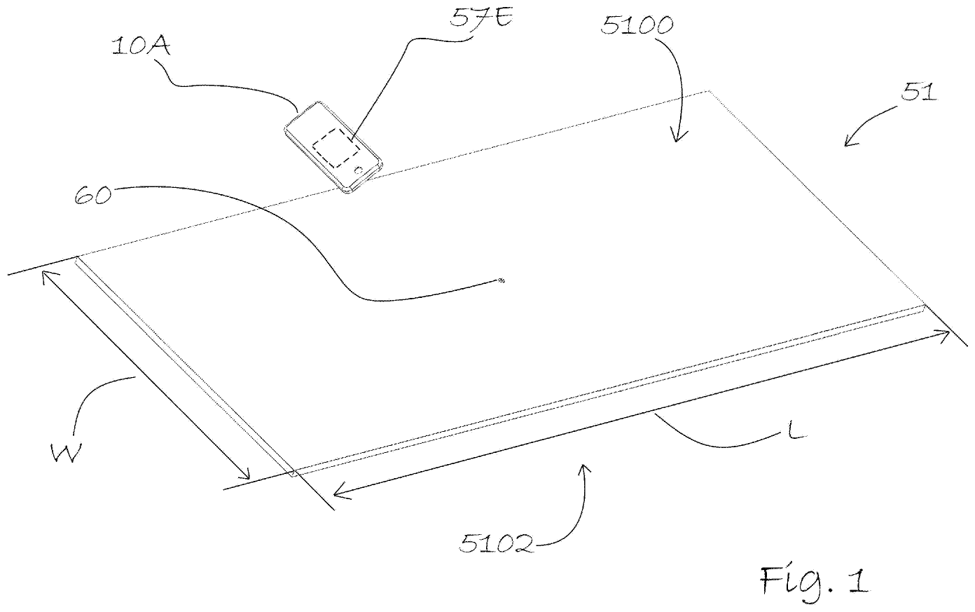

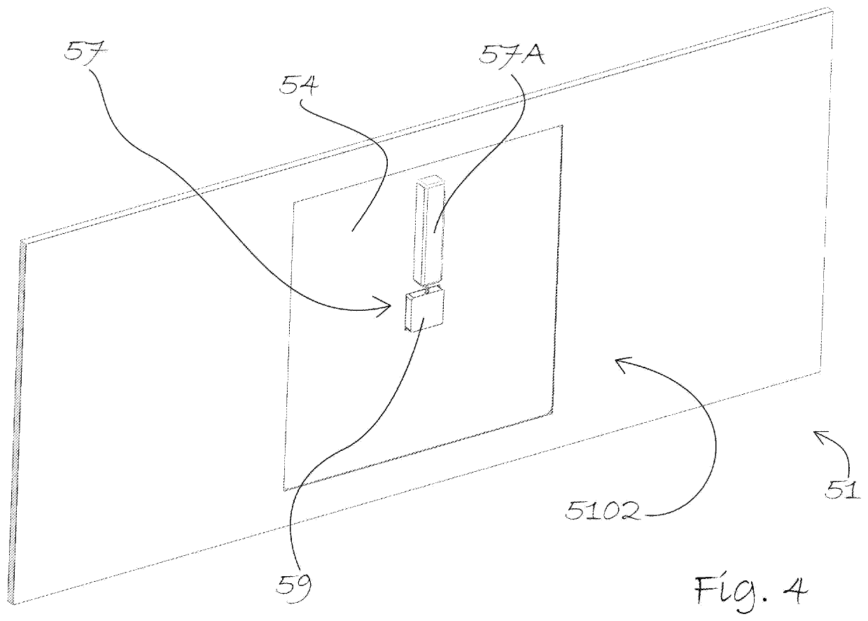

FIGS. 1-5 relate to a covering panel for buildings, according to a particular embodiment of the disclosure, indicated with reference numeral 51.

The panel 51, 51′ can be used, for example, to cover masonry walls or ceilings of buildings, to construct walls, ceilings, false-ceilings, partitions with inner metallic frameworks, theatrical sets, display stands or display cases.

For example, as shown in FIG. 1, the panel 51 can have the overall shape of a flat plate, even non-planar, for example rectangular or square.

Its outer surface forms a major front face 5100 and a major rear face 5102.

The panel 51, 51′ comprises:
a ferromagnetic layer 54 containing ferromagnetic material;
one or more structural layers 52, 53, 56;
a signal light 60, which is visible, at least when it is on, observing the major front face 5100 of the panel 51, 51′ from the outside.

The major front face 5100 is arranged to be oriented towards the observers and/or to face the room or other space the walls or ceilings of which are covered with or formed by one or more panels 51, 51′.

The major rear face is arranged to be hidden from observers, possibly without facing the room or other space the walls or ceilings of which are covered with or formed by one or more panels 51, 51′.

If the panel 51, 51′ covers the pre-existing masonry walls of a room, the major rear face thereof faces towards the masonry walls; if, on the other hand, the panel 51 is part of a partition with a metallic frame, the major rear face thereof faces towards the inside of the partition.

At least one first structural layer can be a layer made of wood, paper, card 52, 56 or other derivatives of wood or cellulose, ceramic materials, terracotta, glass, marble, granite or other stones, plastic materials like, for example, layers of sound-absorbing foam material, other porous sound-absorbing materials, like, for example, glass wool or rock wool panels.

In particular, at least one first structural layer can be made up of boards and blocks of solid wood, multi-layer wood or particle board.

At least one first structural layer can be made of composite materials like, for example, the following: a material comprising a polymeric matrix containing inorganic fillers in an amount equal to or greater than 30% by weight, a polymeric matrix containing inorganic fillers in an amount equal to or less than 80% by weight.

Such a polymeric matrix can, for example, be polymethylmethacrylate based.

Such inorganic fillers can, for example, be calcium carbonate, calcium sulphate, clay, silica, calcium silicate, alumina, carbon black, titanium dioxide, powdered metal or aluminium hydroxide trihydrate based.

Such fillers can comprise particles having average particle size comprised between 1 micron-1 millimetre, and, for example, comprised between 5 micron-0.5 millimetres or between 5-50 micron.

The abovementioned composite materials that form or are part of the first structural layer and/or of possible other structural layers can be, for example, of the type commercialised under the name CORIAN® or AVONITE® and/or described, for example, by one or more of the following patents: U.S. Reissue patent N° 27093, U.S. Pat. Nos. 3,488,246, 3,642,975, 3,847,865, 4,107,135, 5,286,290, U.S. Pat. Nos. 5,958,539, 5,998,028, 6,025,069.

At least one first structural layer is made of such a material and has a thickness such that, if it was shaped like a flat plate, it would have a flexural rigidity Dflex preferably equal to or greater than about 15000 Nmm (Newton per millimetre), more preferably equal to or greater than 20000 Nmm, possibly equal to or greater than 150000 Nmm, possibly equal to or greater than 500000 Nmm, possibly equal to or greater than 2500000 Nmm.

Preferably at least the first structural layer has a flexural rigidity Dflex equal to or less than 3000000 Nmm and more preferably equal to or less than 2000000 Nmm.

The flexural rigidity Dflex is considered determined with the following formula of flat plates:

Dflex=[E*s\hat{ }3]/[12*(1−ν\hat{ }2)]

where
E is Young's modulus, i.e. modulus of elasticity under traction of the material of the structural layer considered expressed in N/mm\hat{ }2;
s is the thickness of the structural layer considered expressed in millimetres;
ν is Poisson's ratio of the material of the structural layer considered.

At least one first structural layer is made of a material such that and has a thickness such that, if it was shaped like a flat plate, it would have a flexural rigidity Dflex preferably equal to or greater than that of a pine wood plate of at least 3 millimetres in thickness, more preferably equal to or greater than that of a pure aluminium or non-alloy steel plate C40 of at least 3 millimetres in thickness, more preferably equal to or greater than that of a pure aluminium or non-alloy steel plate C40 of at least 5 millimetres in thickness.

Preferably at least the first structural layer has a flexural rigidity Dflex equal to or less than 3000000 Nmm and more preferably equal to or less than 2000000 Nmm.

If based on paper, card or other derivatives of cellulose, the first structural layer has a thickness preferably equal to or greater than 0.1 millimetres, more preferably equal to or greater than 0.2 millimetres and possibly equal to or greater than 0.5 millimetres.

The panel 51, 51′ can also be provided with two or more structural layers, at least one of which can, for example, be a layer of gypsum or of gypsum-based material 53, where in the present description, the term “material Y based on substance X” means a material having a content by weight at least equal to 50% of substance X, where the percentage refers to the total weight of the material Y.

In particular, the panel 51, 51′ can comprise at least one cardboard-based first structural layer and another gypsum-based structural layer coupled with the first structural layer.

Advantageously, the various structural layers are glued, welded or otherwise fastened together on their major faces so as to be stiffer at least with regard to flexing.

Preferably, the panel 51, 51′ is made of one or more such materials and has a thickness such that, if it was shaped like a flat plate, it would have a total flexural rigidity Dflex—determined with the abovementioned formula for flat plates—preferably equal to or greater than about 15000 Nmm (Newton per millimetre), more preferably equal to or greater than 20000 Nmm, possibly equal to or greater than 150000 Nmm, possibly equal to or greater than 500000 Nmm, possibly equal to or greater than 2500000 Nmm.

Preferably the panel 51, 51′ has a total flexural rigidity Dflex equal to or less than 7000000 Nmm and more preferably equal to or less than 5000000 Nmm.

Preferably the panel 51, 51′ is made of one or more such materials and has a thickness such that, if it was shaped like a flat plate, it would have a total flexural rigidity Dflex preferably equal to or greater than that of a pine wood plate of at least 3 millimetres in thickness, more preferably equal to or greater than that of a pure aluminium or non-alloy steel plate C40 at least 3 millimetres thick, more preferably equal to or greater than that of a pure aluminium or non-alloy steel plate C40 at least 5 millimetres thick.

Each structural layer can, for example, be substantially continuous and devoid of holes or other through openings, or perforated or formed from a plurality of blocks or tiles separated from one another by voids.

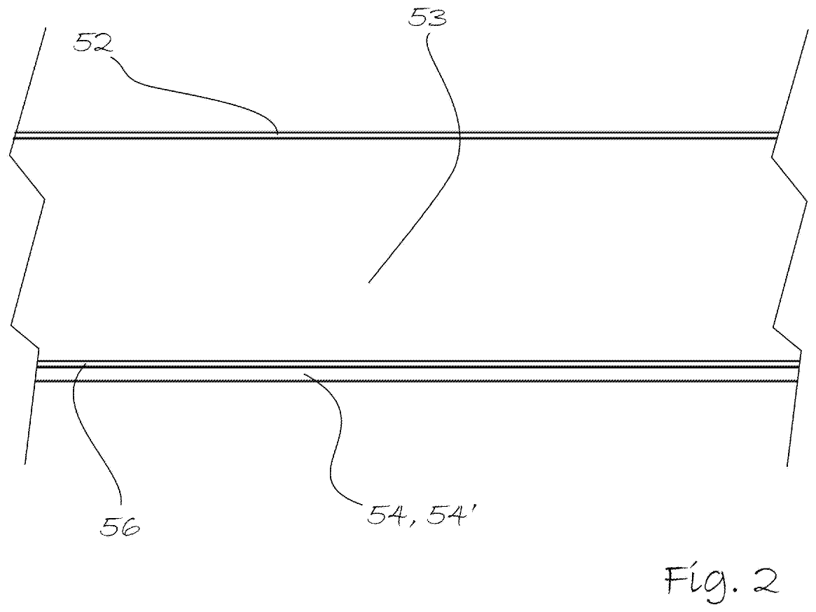

Like in the embodiment of FIG. 2, the panel 51 can comprise, in order, starting from the major front face or from the rear front face, a first structural layer made of paper or cardboard 52, a second structural layer 53 made of gypsum, a third structural layer 56 and a ferromagnetic layer 54.

The latter forms one of the major faces 5100, 5102 of the panel 51.

The ferromagnetic layer 54 can, for example, be glued or fastened through screws to the underlying structural layers 52, 53, 56.

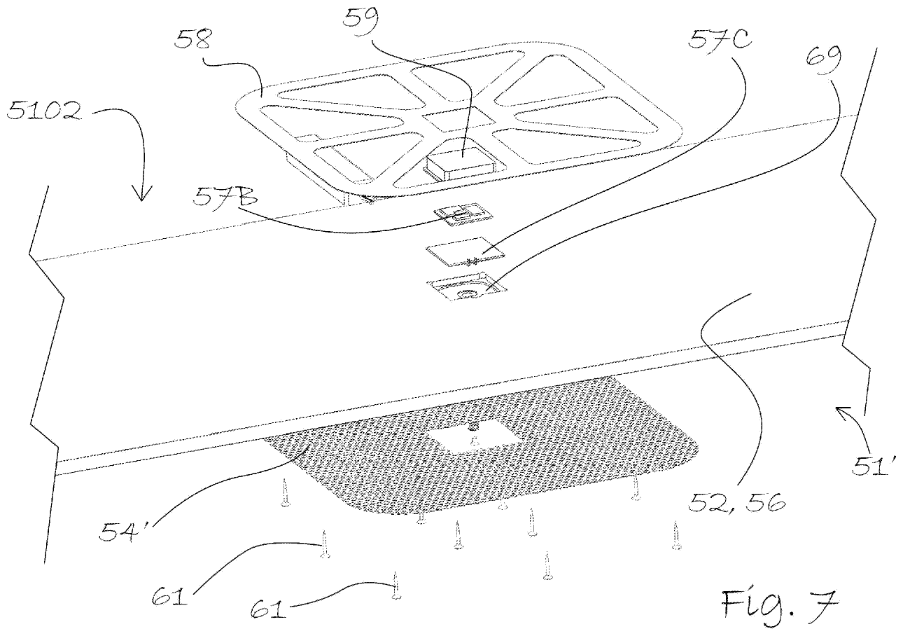

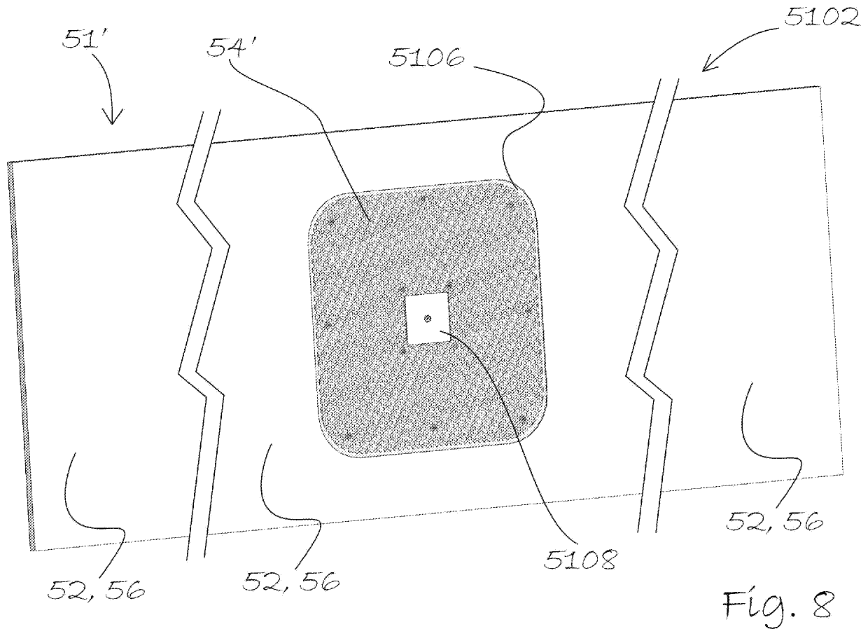

Advantageously, when it forms one of the outer major faces 5100, 5102 of the panel 51, the ferromagnetic layer 54 is formed from or comprises a perforated metallic plate, for example grid-like, so as to more easily retain possible plasterwork (FIGS. 7, 8, 9) or a plate, even solid, which already constitutes the major front face 5100, with aesthetic features.

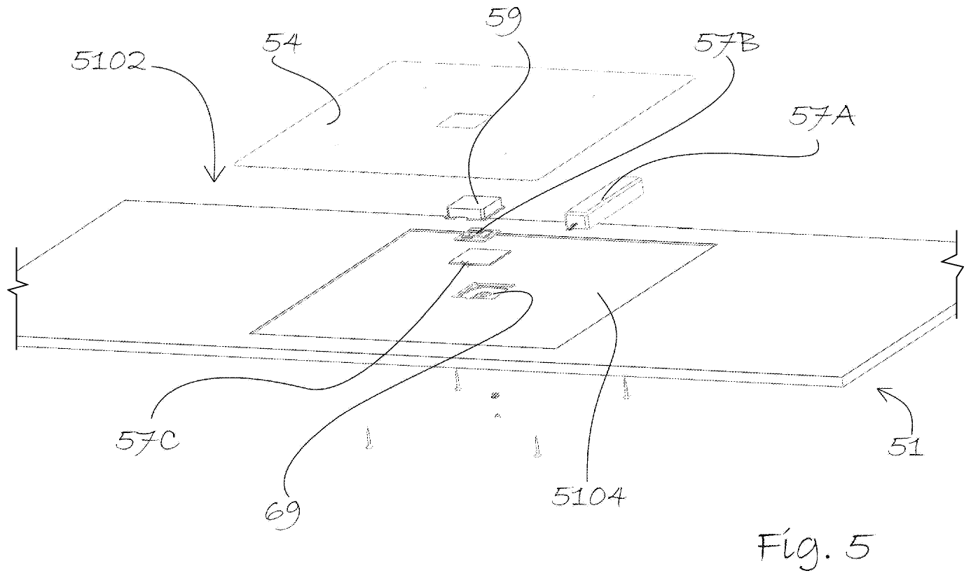

The ferromagnetic layer 54 preferably comprises a sheet of metallic plate that can extend over all or part (FIGS. 5, 7-9) of the plan of the panel 51, over all or part of the plan of a structural layer 52, 53, 56.

Like in the embodiment of FIGS. 1, 3, 4, 5, the ferromagnetic layer 54 can form part of the major rear face of the panel 51.

In this case the ferromagnetic layer 54 can be advantageously inserted in a recess 5104 formed on the major rear face 5102 of the panel 51, so that, for example, the layer 54 is flush with or at a lower level than the rest of the major rear face 5102 of the panel 51.

In an embodiment that is not shown, the ferromagnetic layer 54 can form the entire major rear face of the panel 51.

Preferably the ferromagnetic layer 54, 54′ can possibly be less rigid and/or resistant, at least to flexing, with respect to the first 52, 53, 56 and/or to the possible second structural layer 53, and/or to the assembly of all of the structural layers coupled together.

Preferably, observing the major front face 5100 of the panel 51, the signal light 60 comprises:
a light source 62 arranged inside or behind the first structural layer 52, 53, 56 and/or the ferromagnetic layer 54;
a substantially transparent or translucent protective shield 64 that covers the light source 62 and allows the light emitted by such a light source 62 to be seen or glimpsed.

Advantageously, the light source comprises one or more light emitting diodes (LED).

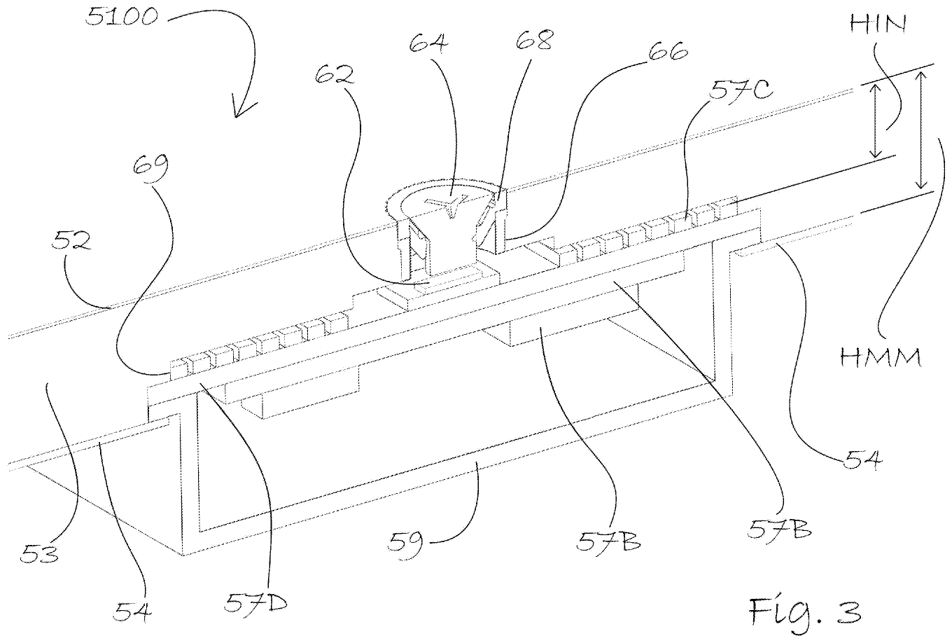

Like, for example, in the embodiment of FIG. 3, the protective shield 64 can extend at least partially through the first structural layer 52, 53, 56 closest to the major front face 5100 and/or through the ferromagnetic layer 54.

The protective shield 64 can extend, for example, along a through hole or other through opening 66.

In this case it crosses the panel 51, either through its first structural layer 52, 53, 56 closest to the major front face 5100, or, more preferably, through at least one gypsum-based second structural layer 53.

Like, for example, in the embodiment of FIG. 3, the protective shield 64 can comprise, for example, a pin, smooth or threaded, or other more or less oblong insert force-fitted or screwed at least into the first structural layer 52, 53, 56 closest to the major front face 5100 and/or through the ferromagnetic layer 54, and more preferably also at least into a second structural layer 53 based on gypsum.

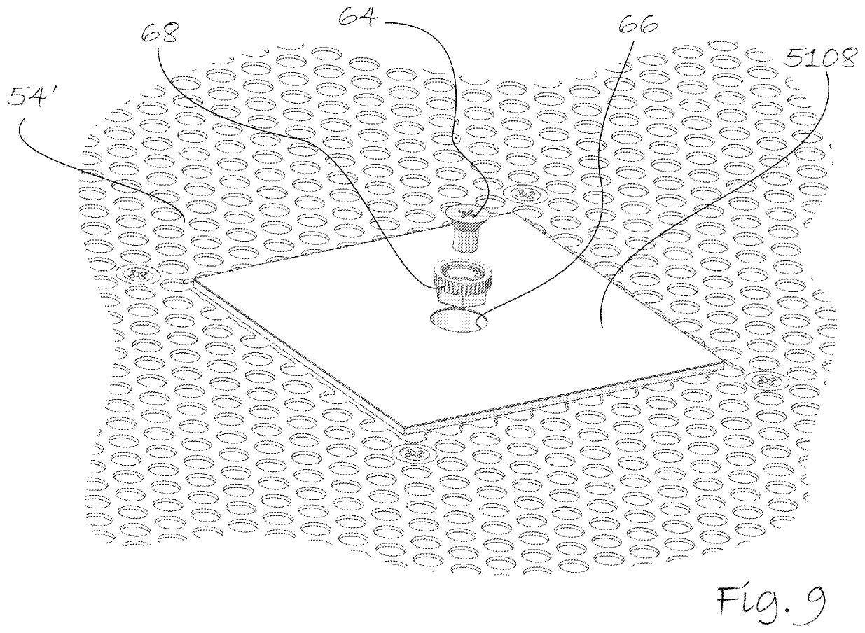

For this purpose, like in the embodiments of FIGS. 3, 9, the panel 51 can comprise an insert with nut screw 68 force-fitted at least into the first structural layer 52, 53, 56 closest to the major front face 5100 and into a possible second structural layer 53 based on gypsum.

The threaded pin, which forms the protective shield 64, can be screwed more or less deeply into the nut screw 68.

The insert with nut screw 68 can be, for example, a square, hexagonal, polygonal or star-shaped nut; or a bush, substantially cylindrical on the outer sides of which there is a ribbing or a plurality of crests and grooves that are substantially parallel, longitudinal to the axis of the internal threading of the insert 68 itself.

In other embodiments that are not shown, the threaded pin that forms the protective shield 64 can be screwed directly into the wood, cardboard or other material derived from wood or cellulose that forms the first structural layer 52, 53, 56 closest to the major front face 5100.

Like in the embodiments of FIGS. 3, 9, the cross sections of the end of the protective shield 64, which face the outside of the panel 51, can have a diameter, a length or a width for example comprised between 0.3-3 centimetres, more preferably comprised between 0.5-2 centimetres and even more preferably comprised between 0.5-1 centimetre.

As shown, for example, in FIG. 3, advantageously the light source 62 is arranged to emit light towards an end of the protective shield 64, this end being such as to allow a sufficient fraction of light to pass inside the protective shield 64 making it come out from the other end of the shield 64 closer to or outside of the major front face 5100 of the panel 51.

In this way, the light emitted by the light source 62 can be seen outside of the panel 51.

When the light source 62 is switched on, the surface of the shield 64 has a luminosity preferably comprised between 0.3-80 lux.

Preferably, the sheet of plate that forms the ferromagnetic layer 54 has an average thickness equal to or greater than 0.1 millimetres, more preferably equal to or greater than 0.2 millimetres, more preferably equal to or greater than 0.4 millimetres, more preferably equal to or greater than 0.6 millimetres and possibly comprised between 0.5-2 millimetres or between 0.2-1 millimetres.

This is to create a magnetic force that is strong enough to fasten to the wall and also support a sufficient variety of electrical load devices 10A like, for example, home appliances and other commonly used electrical or electronic devices having, for example, a weight equal to or less than 20 kg or equal to or less than 30 kg, 40 kg or 60 kg.

In particular, the force of magnetic attraction must preferably prevent the magnetically fastened objects from sliding along the panel itself, even if it is vertical.

Advantageously, the ferromagnetic layer 54 is arranged at an average depth HMM from the major face equal to or less than 13 millimetres, more preferably equal to or less than 10 millimetres and even more preferably equal to or less than 6 millimetres.

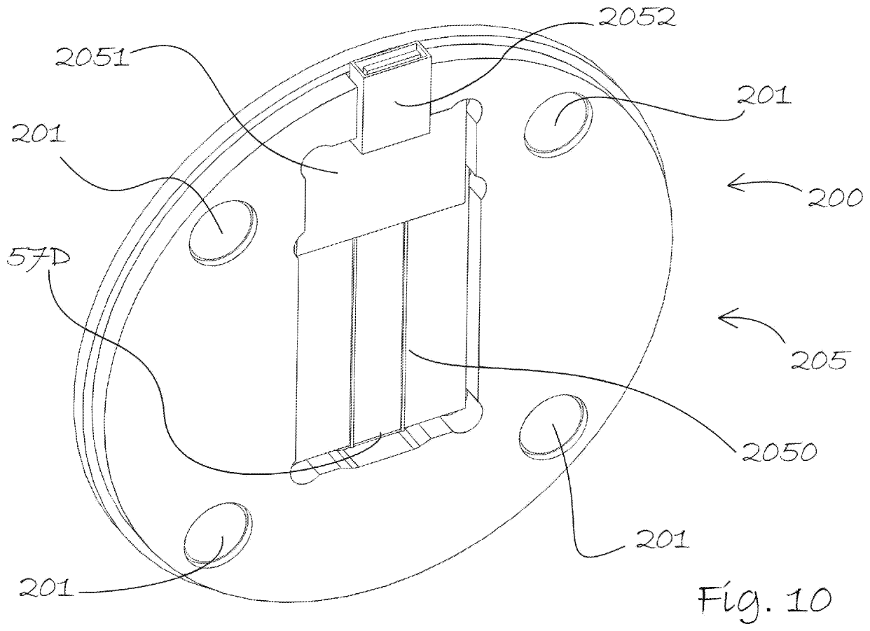

This allows the ferromagnetic layer 54 to be brought sufficiently close to the magnets of devices or other objects to be fastened to the panel 51 such as, for example, the magnets 201 of the fastening support 200 (FIG. 10, 11) in order to fasten such objects with sufficient force.

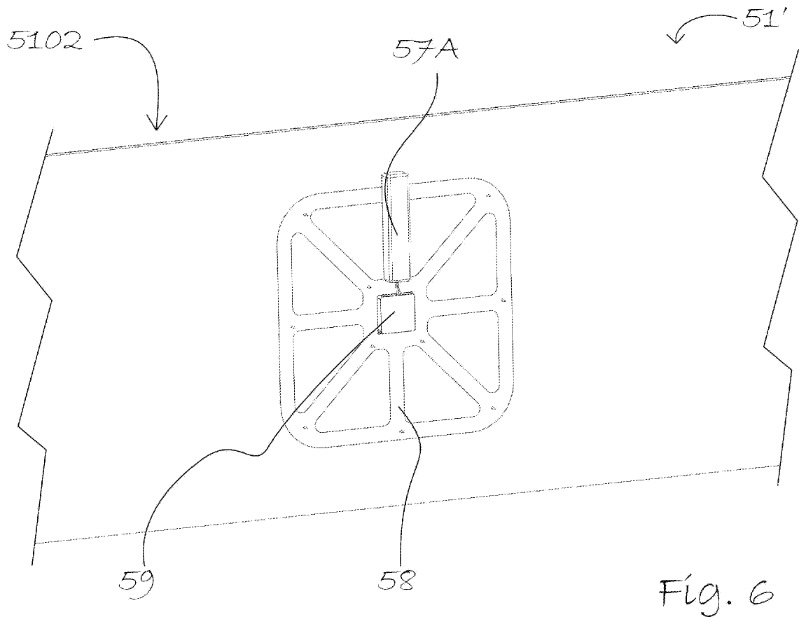

Like in the embodiment of FIGS. 6-9, the ferromagnetic layer 54′ can form part of the major front face 5100 of the panel 51′, reducing to the minimum the distance between ferromagnetic layer 54′ and permanent magnets 201 of the electrical load devices 10A fastened to it. This maximises the magnetic attraction and fastening force of the devices 10A and makes it possible to use less powerful magnets, thus less of a risk in causing accidents.

In this case the ferromagnetic layer 54′ can be advantageously inserted in a recess 5106 formed on the major front face 5100 of the panel 51′, for example, so that the layer 54′ is flush with the rest of the major front face 5106 of the panel 51′ or more internal with respect to the major front face 5100, to facilitate the subsequent plastering of the plate even further.

Preferably the ferromagnetic layer 54′ substantially does not overlap the inductor 57C but, as for example, shown in FIGS. 5, 7, 8, 9, it can be substantially adjacent to it.

For this purpose the recess 5106 is advantageously ring-shaped (FIGS. 7, 8, 9) and, close to its centre, forms a projection from the top that is preferably flat 5108, i.e. preferably at the same level as the major front face 5100 that, like a centrer, allows the central opening of the ferromagnetic layer 54′ to be positioned with precision with respect to the inductor 57C.

Advantageously, the panel 51′ is provided with a plate or other reinforcing structure 58 fastened to at least one part or preferably to all of the structural layers 52, 53, 56 of the panel 51′, for example, through screws or nails 61 (FIG. 7).

Advantageously, the reinforcing layer 58 is also fastened to the ferromagnetic layer 54′ located on the other major front face 5100 of the panel 51′, for example through screws or nails 61 (FIG. 7).

The reinforcing structure 58 reduces the risk of the ferromagnetic layer 54′ to detach from the rest of the panel 51′ if overloaded, for example because a television set or other relatively heavy home appliance has been fastened there.

Moreover, the reinforcing structure 58 helps the plastering operations, to hide the panel 54′ and even out the surface of the major front face 5100 of the panel 51′, making the panel 54′ stay stuck to the recess 5106.

In an embodiment that is not shown, the ferromagnetic layer 54′ can form the entire major front face of the panel 51.

Advantageously, the panel 51 is provided with one or more wireless power supply stations 57 (FIGS. 3-7).

The term wireless power supply, in the present description, is meant to indicate the transfer of electrical energy from an electrical power supply unit to an electrical load without using conducting cables and with an efficiency, deemed to be the ratio between the electrical power received by the electrical load and that transmitted by the power supply unit, equal to or greater than 30%, more preferably equal to or greater than 40%, more preferably equal to or greater than 70% and even more preferably equal to or greater than 90%.

Each wireless power supply station 57 comprises:
a power supply unit 57A arranged, for example, to transform the alternating current of the public electricity mains into direct current or into alternating current of different frequency to that of the public electricity mains;
an inductor arranged to transfer energy to an electrical load device 10A to be powered; the inductor, in the present description, will also be indicated as primary inductor assembly 57C;
preferably, an electronic card 57B powered by the power supply unit 57A and which, in turn, powers the primary inductor assembly 57C.

The term electrical load device 10A in the present description is meant to indicate an electrical or electronic device that must be powered or charged.

In order to be powered with a wireless power supply system, an electrical load device 10A is also provided with its own inductor arranged to receive the electrical energy transmitted by the primary inductor assembly 57C.

The inductor of the electrical load device 10A is also indicated, in the present description, as secondary inductor assembly 57E.

Like in the embodiments shown, the primary inductor assemblies 57C are preferably arranged so as not to rotate or move with respect to the respective secondary inductor assemblies 57E while they power the latter.

Like, for example, in the embodiment of FIGS. 3, 5, 6 the electronic card 57B can be enclosed in and protected by a box or shell 59 located on the major rear face 5102, possibly projecting through a suitable opening formed in the ferromagnetic layer 54, 58 and/or in the structural layers 52, 53, 56.

The electronic card 57B or other electronic card of the panel 51 can comprise an antenna that, through NFC technology or other technologies, makes it possible to identify—through control interfaces (for example, a smartphone app)—one panel 51 among many or more specifically one power supply station 57 among others.

The power supply unit 57A can comprise, for example, a low or ultra-low voltage transformer, which can be fastened, for example, with biadhesive tape or screwed to a major face 5100, 5102 of the panel 51, 54, 58.

The possible electronic card 57B can be arranged, for example, to control the current in the inductor 57C, to actuate the QI protocol or other protocols for wireless power transfer and/or to transmit and receive signals wirelessly, for example, through WiFi, ZigBee, Bluetooth, NFC protocol.

Such a wireless data transceiver—for example, WiFi, ZigBee, Bluetooth—makes it possible to activate, deactivate and more generally remotely control the various functions, for example the power supply unit 57 and the light 62, for example through a remote computer, mobile telephone or smartphone; in the last case a suitable control app can be loaded onto the smartphone.

As shown, for example, in FIG. 3, the primary inductor assembly 57C can comprise a winding comprising one or more electrical conductors wound so as to form one or more coils, substantially flat, preferably fastened on a sheet of ferrite 57D.

For this purpose the inductor 57C is preferably arranged at an average depth HIN from the surface of the major front face 5100, preferably equal to or less than 25 millimetres, more preferably equal to or less than 12 millimetres, more preferably equal to or less than 2 millimetres and even more preferably equal to or less than 1 millimetre (FIG. 3), so as to bring it sufficiently close to the user device to be powered.

Again for this purpose, a corresponding recess 69 having average or maximum depth equal to HIN is advantageously formed on the major rear face 5102 of the panel 51.

The recess 69 can, for example, be made through milling of one or more structural layers 52,53,56.

Advantageously, the LED, or other light source 62 is fastened onto the ferrite 57D or onto the electronic card 57B and is preferably arranged at or close to the centre of the primary inductor assembly 57C (FIG. 3), so as to allow a user to easily and successfully find the position of the wireless power supply station and, more specifically, the position of the primary inductor assembly 57C, even though it is hidden in the panel 51 and invisible from the outside.

Advantageously the signal light 60 is arranged at or close to one of the wireless power supply stations 57, for example at or close to its possible inductor 57C or capacitive plate so as to allow a user to easily find the position of the power supply station 57 even though it is hidden in or behind the covering panel 51, 51′.

The term “arranged at or close to one of the wireless power supply stations 57” is meant to indicate that the signal light 60 is in a position such that by placing the electrical load device 10A over it the power supply station 57 manages to charge it with an efficiency equal to or greater than 30%.

Advantageously, the panel 51 has a length L comprised between 1-2 metres and, for example, equal to about 1.2 metres (FIG. 1).

The panel 51 can have a length L and/or a width W comprised, for example, between 0.5-4 metres, between 0.5-3 metres, between 0.5-2 metres or between 0.4-1.5 metres.

Advantageously, the panel 51 has a width W comprised between 1-2 metres, more preferably comprised between 0.4-0.8 metres and even more preferably roughly equal to 0.5 metres.

These dimensions make it possible to produce on an industrial scale prefabricated panels 51 provided with signal light 62 and wireless charger 57 that are particularly easy to handle, easy to set up and adapt to other panels of the most commonly used formats, as well as being cost-effective.

A possible example of use and of operation of the panel 51 will now be described.

The installer of plasterboard walls or ceiling or the electrician can purchase the panels 51 for example, already complete with the wireless power supply stations 57 and in particular with the signal light 60.

Once the power supply unit 57A has been connected to the external electricity mains, or the electronic card 57B has been connected to the power supply unit 57A, or the electronic card 57B has been directly connected to the home or local network, in the case in which it is already at the correct direct voltage, the installer or electrician mounts the panels on a suitable support structure, such as a pre-existing masonry wall or ceiling or a support frame, of the per se known type.

The panel or panels 51 are then plastered, adjusting the protective shield 64 with a screwdriver so as to keep it flush with the finished surface of the visible major face 5100.

Depending on the different desired aesthetic effects, it is possible to cover the outer end of the protective shield 64 with a light layer of plaster or leave it without plaster, allowing the possible adjustment, removal and replacement thereof.

In turn, paintwork may or may not be applied to the outer end of the protective shield 64.

The panel 51 thus constitutes a modular component that can easily be industrialised and suitable for mass production to make coverings of buildings or construction of new parts.

The LED or other light source 62 can, advantageously, be always switched on and visible from inside the room, or other space covered by panels 51, through the protective shield 64 so that the end users always and easily can find the position of the wireless power supply station and, more specifically, of the primary inductor assembly 57C, even if it is hidden in or behind the panels 51.

Moreover, if it is switched off it can signal, for example, that the wireless power supply station 57 lacks a power supply.

The LED or other light source 62 can emit a fixed or variously intermittent light, and moreover it can emit a light of a single colour, for example white, or of many colours, for example red, green and blue, if the LED or other light source 62 is of the RGB type, so as to transmit more information to the observer.

Such information can communicate, for example, not only whether the power supply unit 57 is switched on, off or out of order, but can distinguish between the out of order condition and the lack of power supply upstream, or can signal whether the WiFi emitter or other wireless data transmitter, possibly incorporated in the electronic card 57B or more generally in the panel, is switched on, off, inactive or in transmission phase.

Arranging the outermost end of the shield 64 flush with the outer surface of the major front face 5100 is particularly advantageous because thus the visibility of the light source 62 is maximum and at the same time, not projecting from the surface of the panel 51, it allows the devices, which will be magnetically fastened there, to adhere with the maximum possible surface to the ferromagnetic layer 54.

More in particular the panels 51 described earlier can be advantageously used to make, for example, the lighting system object of international patent application WO2018/025230A1 and comprising at least one lighting device advantageously equipped with means necessary for the autonomous or manual movement thereof on a support surface.

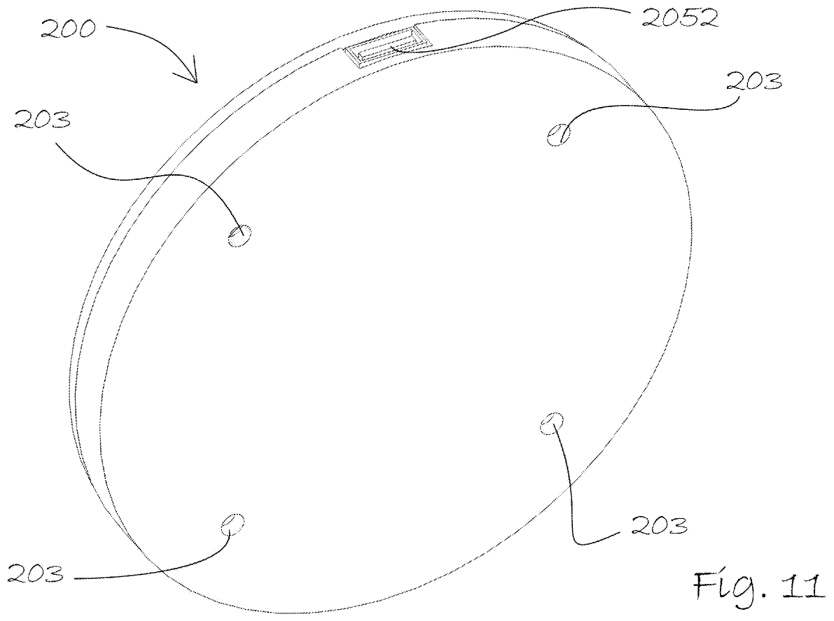

FIGS. 10, 11 show a first example of fastening support 200 through which an electrical load device 10A, like, for example, a television, radio, recorder, video recorder, stereo speaker system, projector, mobile telephone and landline telephone, smartphone, computer, thermostat, intercom, clock, pressure gauge, hygrometer, closed circuit video camera screen, microphone, switch, sensor for alarm and other systems, siren, wi-fi repeater, acoustic signal or other alarms, doorbell, loudspeaker, spotlight, lamps or other lighting bodies for lighting a room or other spaces, warning light or other luminous indicator, transceiver apparatuses, other home appliances or other electrical and/or electronic devices, can be fastened magnetically to walls or ceilings covered by the panels 51, 51′, even though such electrical load devices 10A do not have their own permanent magnets 201.

The abovementioned lighting bodies, in order to light a room or other spaces, emit a total light flow preferably equal to or greater than 30 lumens, more preferably equal to or greater than 40 lumens and possibly equal to or greater than 60 lumens, 100 lumens, 200 lumens, 400 lumens, 800 lumens and possibly even equal to or greater than 1500, 2300, 3000 lumens.

More generally, the ferromagnetic property of the panel can be exploited to easily fasten and remove decorative and light diffusion elements (coloured diffusors, etc.), as well as to fasten other decorative and non-decorative elements such as paintings, towel bars, key holders, shelves, object holders of various kinds.

For this purpose, the fastening support, indicated with reference numeral 200, is provided with:
one or more magnets 201 arranged, for example, close to or at the corners of the support 200 if it has, for example, an overall polygonal shape;
a fastening system 203 arranged to fasten the home appliance or other electrical load device 10A to the support 200;
a power supply unit 205 that advantageously is a wireless power supply unit, for example of the inductive or capacitive type.

Like in the embodiment of FIGS. 10, 11, the fastening system 203 can comprise one or more threaded holes in which to screw screws that fasten the home appliance or other electrical load device 10A.

Alternatively, the fastening system 203 can comprise threaded pins, snap clips or other mechanical locking systems.

The power supply unit 205 is advantageously provided with:
a reel or coil winding 2050 that forms one of the abovementioned secondary inductor assemblies 57E,
an electronic control circuit 2051 arranged, for example, to actuate the QI protocol or other wireless power transfer protocols and to transfer the suitable voltage/current to the electrical load device.

The power supply unit 205, or more generally the winding 2050, can also be provided with a layer of ferrite 57D to shield the electromagnetic emissions emitted by the same windings of the primary and secondary inductor assemblies 57C, 57E.

The power supply unit 205 can, through a mechanical socket or mechanical current plug 2052, power various electrical or electronic devices or other electrical load devices 10A.

The power supply unit 205 is in turn powered by the primary inductor assembly 57C and thus constitutes a possible example embodiment of the abovementioned secondary inductor assembly 57E.

The fastening support 200 can be fastened to a panel 51 by simply bringing them close together so that the attraction between the magnets 201 and the ferromagnetic layer 54, 54′ of the panel makes them stick together, locking them in a mutually fixed position.

The fastening support 200 makes it possible to reversibly fasten electrical, electronic and other types of devices to vertical walls or to ceilings through the fastening systems 203, choosing and changing the position thereof with extreme freedom.

Preferably, the magnets 201 and/or the wireless power supply unit can be arranged inside the possible casing or shell of the electrical load device 10A or be permanently fixed to such a casing or shell.

The fastening support 200 is not indeed necessary, for example if the home appliances or other electrical load devices 10A to be fastened to the panels 51, 51′ are already provided with their own magnets 201 and possibly with their own wireless power supply unit, for example of the inductive type, arranged to be powered by the wireless power supply unit 57 of one of the panels 51, 51′.

As depicted in FIG. 1, the electrical load device 10A can preferably be a smartphone and, even more preferably, an Iphone 8 currently commercialised by the firm Apple (California) and already equipped with a secondary inductor assembly 57E adapted for cooperating with the panel 51, 51′ and more specifically with a wireless power supply station 57.

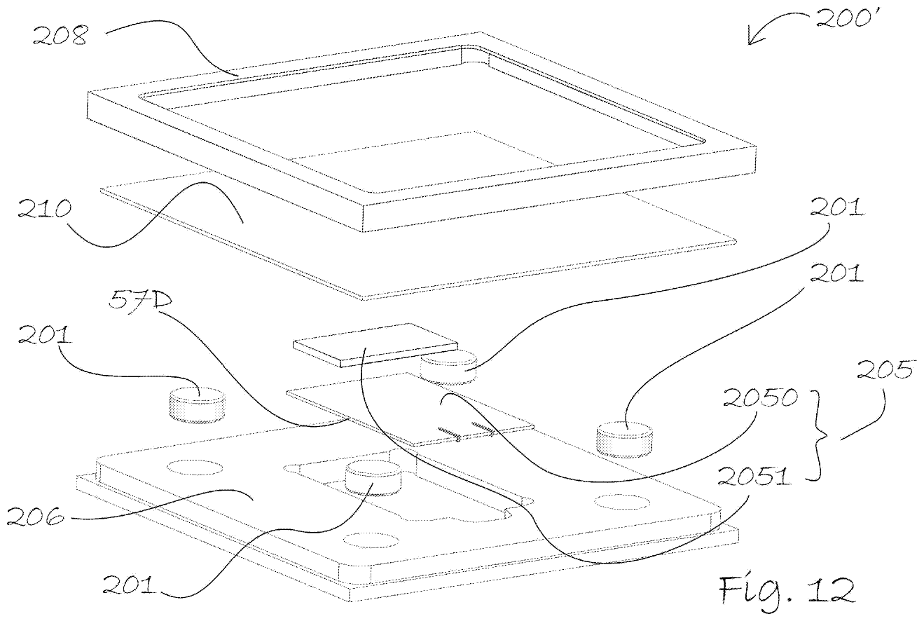

FIG. 12 shows an example of electrical load 10A powered by a panel 51, 51′ described earlier, specifically a lamp or spotlight.

The lamp 200′ can comprise a main body 206, to which the permanent magnets 201 are fixed, and a fastening framework 208, fixed to the main body 206 so as to form a space in which the light source 210, in this specific case an OLED (Organic Light Emitting Diodes) panel can be inserted, to be powered.

Advantageously, the lamp 200′ comprises a wireless power supply unit 205, as described earlier, in turn comprising the reel or coil winding 2050 and the electronic control circuit 2051.

A particularly advantageous use of the panels 51, 51′, described earlier, is to use them to cover pre-existing walls or ceilings, for example made of masonry, or to make new walls and ceilings in a building, by arranging a certain number of panels 51, 51′ each provided with at least one wireless power supply unit 57 at various points of a room, like, for example, a dwelling, an office or another space.

By doing so, the finished room, covered with the panels, can have an unblemished and basic appearance, free from visible sockets, wires or cable glands. The room is, however, provided with multiple charging points, hidden for example behind the panels 51, 51′, which cover the walls, and which allow a user to install home appliances and electrical and electronic devices, in general of greatly varying types, in the room, in the most varied positions with extreme freedom.

A room thus covered and provided with multiple hidden charging points manages to adapt with extreme flexibility to the changing requirements of residents, or other users, over time, very often without any need to modify the cabling of the room and even less so to have specialised workers carry out other work.

Consider, for example, the different electrical or electronic devices to be installed or moved in a room of a growing child, or if the room is converted to an office and vice-versa, or the installation of a new device such as a security camera, an additional sensor of an anti-burglar system or a new gadget.

Consider, moreover, the advantage given by the installation of a panel 51, 51′ close to a shower or bath. It would be the only safe solution, avoiding the risk of electrocution given by a standard socket, completely safely installing users 200, 200′ or more general a load device 10A with IP 66 or higher characteristics.

A dwelling, provided with multiple hidden wireless power supply units, meets the current market trend of offering increasing numbers of electrical and electronic devices connected to the Internet, or other global, local or regional digital network, and arranged to communicate wirelessly, for example through WiFi, Bluetooth or Zigbee technology, is thus configured to receive a large amount of such devices with extreme freedom.

The example embodiments described earlier can undergo different modifications and variations, without departing from the scope of protection of the present disclosure.

For example, the wireless power supply station 57 can also be of the capacitive and not only inductive type.

The ferromagnetic layer 54, 54′ can be not only a simple ferrous alloy or a suitable steel, but also a permanently magnetized material; in this case the magnets 201 of the fastening support 200 or of the electrical load device 10A can be replaced by simple blocks, plates or other inserts of ferromagnetic material that is not permanently magnetized.

Advantageously, the LED or other light source 62 can be fastened, not only to the centre of the primary inductor assembly 57C, but also in other more peripheral areas thereof, or even not on the winding, but close to it, so as to still allow a user to easily and unmistakably find the position of the primary inductor assembly 57C, even though it is hidden in the panel 51 and invisible from the outside. The panels 51, 51′ can have an overall shape that is not only substantially flat, but also shells with single or double curvature, like, for example, portions of cylindrical surfaces or caps.

The fact that such expressions appear in various passages of the description does not mean that they necessarily only refer to the same embodiment.

Moreover, when a feature, element or structure is described in relation to a particular embodiment, it should be observed that it is within the capability of the average person skilled in the art to apply such a feature, element or structure to other embodiments.

Reference numerals that differ only due to different superscripts, e.g. 21′, 21″, 21^{III} unless otherwise specified indicate different variants of an element called the same way.

Moreover, all of the details can be replaced by technically equivalent elements.

For example, the materials used, as well as the dimensions, can be whatever according to the technical requirements.

The examples and lists of possible variants of the present application should be understood as non-exhaustive lists.

1) A covering panel for buildings, the outer surface of which forms a major front face and a major rear face, the covering panel comprises:
a ferromagnetic layer containing ferromagnetic material;
one or more structural layers made of one or more materials which are substantially non-ferromagnetic;
a signal light, which is visible, at least when the signal light is on, observing the major front face of the covering panel from the outside;
one or more wireless power supply stations, each of which is arranged for supplying electrical power to one or more electrical or electronic devices, wherein the signal light is arranged at or close to one of the one or more wireless power supply stations to allow a user to find the position of the one or more wireless power supply stations, even though the one or more wireless power supply stations is hidden in or behind the covering panel.

2) The covering panel, according to claim 1, wherein the signal light is arranged inside or behind at least one of the structural layers or the ferromagnetic layer.

3) The covering panel, according to claim 1, comprising a substantially transparent or translucent protective shield that covers the light source and allows emitted light from outside of the same covering panel to be seen or glimpsed.

4) The covering panel, according to claim 3, wherein the protective shield extends, at least partially, across at least one of the one or more structural layers or across the ferromagnetic layer.

5) The covering panel, according to claim 4, wherein the protective shield comprises a pin or other insert fitted with interference or screwed into at least one of the one or more structural layers or through the ferromagnetic layer.

6) The covering panel, according to claim 4, wherein the protective shield engages with the ferromagnetic layer or with at least one of the one or more structural layers inserting, at least partially, into an opening made in at least one of the one or more structural layers or in the ferromagnetic layer.

7) The covering panel, according to claim 4, comprising an insert in which a nut screw is formed, in which the pin forming the protective shield is screwed.

8) The covering panel, according to claim 1, wherein at least one of the one or more structural layers is made of a gypsum or cardboard material.

9) The covering panel, according to claim 1, wherein at least one of the one or more structural layers is made of a wood material, or another material derived from wood or cellulose, or is made of ceramic, glass, terracotta, or plastic materials.

10) The covering panel, according to claim 1, wherein at least one of the one or more wireless power supply stations comprises one or more primary inductor assemblies each of which the one or more primary inductor assemblies comprises a winding arranged for wireless transmission of electrical energy to an electrical or electronic device to be powered mainly through electromagnetic induction.

11) The fastening system for electrical or electronic equipment comprising:
one or more covering panels with the features according to claim 1; and
an electrical or electronic device, or another device, provided with one or more magnets or ferromagnetic inserts arranged for being fastened, through magnetic attraction, to one or more of the covering panels, also when the one or more of the covering panels are arranged substantially vertically or suspended under a ceiling.

12) The fastening system, according to claim 11, comprising a fastening support arranged for being fastened to the electrical, electronic device, and comprising one or more magnets or ferromagnetic inserts arranged for being fastened, through magnetic attraction, to one or more of the covering panels, also when the one or more of the covering panels are arranged substantially vertically or suspended under a ceiling.

13) The electrical or electronic device comprising one or more magnets or ferromagnetic inserts arranged for being fastened, through magnetic attraction, to one or more of the covering panels having a ferromagnetic layer containing ferromagnetic material, one or more structural layers made of one or more materials which are substantially non-ferromagnetic, a signal light, which is visible, at least when the signal light is on, observing the major front face of the covering panel from the outside, one or more wireless power supply stations, each of which is arranged for supplying electrical power to one or more electrical or electronic devices, wherein the signal light is arranged at or close to one of the one or more wireless power supply stations to allow a user to find the position of the one or more wireless power supply stations, even though the one or more wireless power supply stations is hidden in or behind the covering panel, or to one or more of the covering panels of a system having the features according to claim 11, also when the one or more of these covering panels are arranged substantially vertically or suspended under a ceiling.

14) The electrical or electronic device according to claim 13, comprising a secondary inductor assembly which is arranged for:
receiving the electrical energy transmitted by a primary inductor assembly of a wireless power supply station of a covering panel having a ferromagnetic layer containing ferromagnetic material, one or more structural layers made of one or more materials which are substantially non-ferromagnetic, a signal light, which is visible, at least when the signal light is on, observing the major front face of the covering panel from the outside, one or more wireless power supply stations, each of which is arranged for supplying electrical power to one or more electrical or electronic devices, wherein the signal light is arranged at or close to one of the one or more wireless power supply stations to allow a user to find the position of the one or more wireless power supply stations, even though the one or more wireless power supply stations is hidden in or behind the covering panel, or another wireless power supply system; and
supplying power to the rest of the electrical or electronic device.

15) The electrical or electronic device, according to claim 13, comprising one or more of the following items: overhead lamp, spotlight or lamp to illuminate a room or other space, television, radio, recorder, video recorder, stereo speaker system, projector, mobile telephone and landline telephone, smartphone, computer, thermostat, intercom, clock, pressure gauge, hygrometer, closed circuit video camera screen, monitor for displaying images, microphone, switch, sensor, acoustic speaker, video camera, camera, dispensers for fragrances, scents, medicines, insecticides, indoor insect repellents, fan, vacuum cleaner, siren, acoustic signal or other alarms, wi-fi repeater, remote control.

16) A method for fastening electrical or electronic equipment, the method including the following steps:
providing one or more covering panel having a ferromagnetic layer containing ferromagnetic material, one or more structural layers made of one or more materials which are substantially non-ferromagnetic, a signal light, which is visible, at least when the signal light is on, observing the major front face of the covering panel from the outside, one or more wireless power supply stations, each of which is arranged for supplying electrical power to one or more electrical or electronic devices, wherein the signal light is arranged at or close to one of the one or more wireless power supply stations to allow a user to find the position of the one or more wireless power supply stations, even though the one or more wireless power supply stations is hidden in or behind the covering panel;
providing a wall or a ceiling formed or covered by one or more covering panels; and
fastening an electrical or electronic device, with the features according to claim 11 to one of said covering panels through magnetic attraction between the magnets and the ferromagnetic layer of the covering panel.

17) The method for fastening and supplying power to electrical and electronic equipment according to claim 16, wherein the one or more covering panels have the features according, the electrical or electronic device is equipped with its own secondary inductor, and comprising the step of said secondary inductor receiving electrical energy from the primary inductor assembly of the one or more covering panels through a wireless power transmission system.

18) The covering panel according to claim 1, wherein the signal light is arranged at or close to an inductor or a capacitive plate.

19) The electrical or electronic device according to claim 13, wherein the signal light is arranged at or close to an inductor or a capacitive plate.

20) The electrical or electronic device according to claim 14, wherein the signal light is arranged at or close to an inductor or a capacitive plate.

21) The method for fastening and supplying power to electrical and electronic equipment according to claim 16, wherein the signal light is arranged at or close to an inductor or a capacitive plate.
